(19) United States
(12) Patent Application Publication
(10) Pub. No.: US 2015/0063110 A1
(43) Pub. Date: Mar. 5, 2015

(54) PROGRAMMABLE SENSOR NETWORKING APPARATUS AND SENSOR NETWORKING SERVICE METHOD USING THE SAME

(71) Applicant: Electronics and Telecommunications Research Institute, Daejeon-city (KR)

(72) Inventors: Young-Hwan CHOI, Daejeon (KR); Yun-Chul Choi, Daejeon (KR); Sang-Jin Jeong, Daejeon (KR)

(73) Assignee: Electronics and Telecommunications Research Institute, Daejeon-city (KR)

(21) Appl. No.: 14/290,163

(22) Filed: May 29, 2014

(30) Foreign Application Priority Data
Sep. 4, 2013 (KR) 10-2013-0106252
Feb. 12, 2014 (KR) 10-2014-0016122

(51) Int. Cl. H04L 12/24; H04W 4/00; H04L 12/755

(52) U.S. Cl. CPC H04L 41/0833; H04L 45/021; H04W 4/005
USPC 370/235

(57) ABSTRACT

Disclosed herein is a programmable sensor networking apparatus. In accordance with an embodiment, the sensor networking apparatus includes a gateway for receiving application service information from an application, generating information to be processed by each sensor node based on the received application service information, and transmitting the generated information to each sensor node, and one or more sensor nodes for receiving the information to be processed from the gateway, and processing the received information.

### CROSS REFERENCE TO RELATED APPLICATIONS

This application claims the benefit of Korean Patent Application Nos. 10-2013-0106252, filed on Sep. 4, 2013 and 10-2014-0016122, filed on Feb. 12, 2014, which are hereby incorporated by reference in their entirety into this application.

### BACKGROUND OF THE INVENTION

1. Technical Field

The present invention relates generally to a programmable sensor networking apparatus and a networking service method using the sensor networking apparatus and, more particularly, to technology for combining the concept of software defined networking with sensor networking technology.

2. Description of the Related Art

A typical sensor network differs greatly from other existing networks from the standpoint of original philosophy. For example, one of the basic forms of existing networks is that intended for data exchange and communication between networks as in the case of, for example, peer-to-peer (P2P) networks. In contrast, a sensor network is based upon the Publish-Subscribe (PS) paradigm of distributing sensor nodes to areas of limited access and providing required information to users via interaction between the sensor nodes. Due thereto, on condition that it is not easy to reuse and manage a sensor node that has been installed once, the sensor network has limited resources from the standpoint of various types of functions such as low cost-based power supply, computing, and memory functions. This is the reason why a sensor network has application-centered characteristics. That is, a sensor networking protocol is independently designed and operated for specific application and services rather than being designed to have universal features for the purpose of satisfying all applications and services.

In this way, the characteristics of application-centered sensor networking are advantageous in that networking service optimized for a specific application can be provided, but this may act as a fatal disadvantage from another standpoint. That is, when the lifetime of a sensor network installed in one area is not finished, even if an application service is terminated, the sensor network must be able to be reused for another application service. However, since a sensor network is optimized to suit only a specific application service, it is difficult to reuse a wireless sensor network that is installed once for another application service if the specific application service has been completed. Korean Patent Application Publication no. 10-2012-0024175 discloses technology related to a method and apparatus for processing sensing information in a wireless sensor network.

Further, since a typical sensor network does not have obligatory requirements of having to be equipped with all Transmission Control Protocol (TCP)/Internet Protocol (IP) stacks depending on network characteristics, a sensor node must perform all functions for a control plane and a data plane due to the application-centered design in most cases. Consequently, overhead caused by the performance of such functions unnecessarily promotes the energy consumption of all nodes in the sensor network, thus causing negative results of rather shortening the lifetime of the network.

### SUMMARY OF THE INVENTION

Accordingly, the present invention has been made keeping in mind the above problems occurring in the prior art, and an object of the present invention is to provide a programmable sensor networking apparatus and a sensor networking service method using the apparatus, which combine the concept of software defined networking with sensor networking so as to overcome the disadvantage of limited usability caused by the application-centered characteristics of an existing sensor network.

In accordance with an aspect of the present invention to accomplish the above object, there is provided a programmable sensor networking apparatus, including a gateway for receiving application service information from an application, generating information to be processed by each sensor node based on the received application service information, and transmitting the generated information to each sensor node, and one or more sensor nodes for receiving the information to be processed from the gateway, and processing the received information.

Preferably, the gateway may include an application management unit for receiving the application service information from the application, and transmitting networking information to a network operation unit based on the received application service information, and the network operation unit for determining networking methods for respective application services based on the networking information received from the application management unit.

Preferably, the network operation unit may generate pieces of information about flow tables for respective sensor nodes based on the determined networking methods, and transmits the pieces of flow table information to the respective sensor nodes.

Preferably, each of the flow tables may include one or more of a forwarding flow table and an in-network flow table for each sensor node.

Preferably, the gateway may further include a topology management unit for receiving one or more of node location information in a network and link information from each sensor node, and managing topology information of the sensor node in the network.

Preferably, the gateway may further include a node energy management unit for receiving energy state information including residual energy information from each sensor node and managing energy information of the sensor node in the network.

Preferably, each sensor node may include a data forwarding unit for managing a forwarding flow table received from the gateway, and processing an input packet based on the forwarding flow table.

Preferably, each sensor node may further include an in-network processing unit for managing an in-network flow table received from the gateway, and if the input packet is a packet for in-network processing, reprocessing data included in the input packet based on the in-network flow table, and a data cache unit for storing the data reprocessed by the in-network processing unit.

Preferably, each sensor node may further include a data plane support unit for receiving information to be processed from the gateway, and transferring the received information to a corresponding unit so as to process the received information.

Preferably, each sensor node may include a location processing unit for transferring location information of the sensor node to the gateway in response to a request of the gateway, and a power processing unit for transferring power information of the sensor node to the gateway in response to a request of the gateway.

Preferably, each sensor node may further include a movement processing unit for processing a control packet related to support of mobility if the sensor node is moved.

Preferably, each sensor node may further include a control plane support unit for receiving information to be processed from the gateway, transferring the received information to a corresponding unit so as to process the received information, receiving results of processing from the unit, and transmitting the processing results to the gateway.

In accordance with another aspect of the present invention to accomplish the above object, there is provided a sensor networking service method, the method being performed by a gateway of a programmable sensor networking apparatus, including receiving one or more application services from an application, determining information to be collected from one or more sensor nodes, based on the received application services, transmitting request information for the information to be collected to each sensor node, receiving response information to the request information from each sensor node, determining information to be processed by each sensor node based on the received response information, and transmitting the information to be processed to each sensor node.

Preferably, the request information may include the information to be collected having one or more of location information and residual energy information of each sensor node, identifications (IDs) of the respective application services, and gateway information, and the information to be processed by each sensor node includes one or more of networking information including a routing path and in-network processing information.

Preferably, the sensor networking service method may further include receiving information about revision or addition information of an application service from the application, re-determining information to be processed by each sensor node based on the received revision or addition information of the application service, and transmitting the re-determined information to be processed to each sensor node.

Preferably, the sensor networking service method may further include receiving event-related information from each sensor node, revising information to be processed by each sensor node for an existing application service based on the received event-related information, and transmitting the revised information to be processed by each sensor node to the corresponding sensor node.

In accordance with a further aspect of the present invention to accomplish the above object, there is provided a sensor networking service method, the method being performed by each sensor node of a programmable sensor networking apparatus, including receiving a packet to be processed from a gateway, performing a data forwarding procedure on the received packet, based on a forwarding flow table, and if in-network processing of the packet is required, performing an in-network processing procedure on the packet, based on an in-network flow table.

Preferably, performing the data forwarding procedure may include analyzing header information of the received packet, searching the forwarding flow table for an entry, a Match field of which matches the analyzed header information, and processing the packet depending on an Action field of the entry found in the forwarding flow table.

Preferably, the sensor networking service method may further include searching the in-network flow table for an entry, an In-Net-ID field of which matches the analyzed header information, recalculating data included in the packet depending on a Calculation field of the entry found in the in-network flow table, and processing the packet depending on an Action field of the found entry.

Preferably, recalculating the data included the packet may be configured to, if two or more entries are found as a result of search, recalculate data included in the packet in a sequence of entries having higher priority based on a Priority field of the found entries.

### BRIEF DESCRIPTION OF THE DRAWINGS

FIG. 1 is a conceptual diagram showing a sensor networking apparatus according to an embodiment;

FIG. 2 is a diagram showing the configuration of a sensor networking apparatus according to an embodiment;

FIG. 3 is a diagram illustrating the structure of the flow table of a sensor node according to an embodiment;

FIG. 4 is a diagram showing the values of the action field of the flow table of FIG. 3;

FIGS. 5 and 6 are diagrams showing an example of a networking service performed by the sensor networking apparatus according to an embodiment;

FIGS. 7 and 8 are diagrams showing another example of a networking service performed by the sensor networking apparatus according to an embodiment;

FIGS. 9 and 10 are diagrams showing a further example of a networking service performed by the sensor networking apparatus according to an embodiment;

FIG. 11 is a flowchart showing a sensor networking service method performed by a gateway according to an embodiment;

FIG. 12 is a flowchart showing a sensor networking service method performed by the gateway according to another embodiment;

FIG. 13 is a flowchart showing a sensor networking service method performed by the gateway according to a further embodiment; and

FIG. 14 is a flowchart showing a sensor networking service method performed by a sensor node according to an embodiment.

### DESCRIPTION OF THE PREFERRED EMBODIMENTS

Details of other embodiments are included in detailed description and attached drawings. The features and advantages of technology disclosed in the present invention and methods for achieving them will be more clearly understood from a detailed description of the following embodiments taken in conjunction with the accompanying drawings. Reference now should be made to the drawings, in which the same reference numerals are used throughout the different drawings to designate the same or similar components.

Hereinafter, embodiments of a programmable sensor networking apparatus and a networking service method using the sensor networking apparatus will be described in detail with reference to the attached drawings.

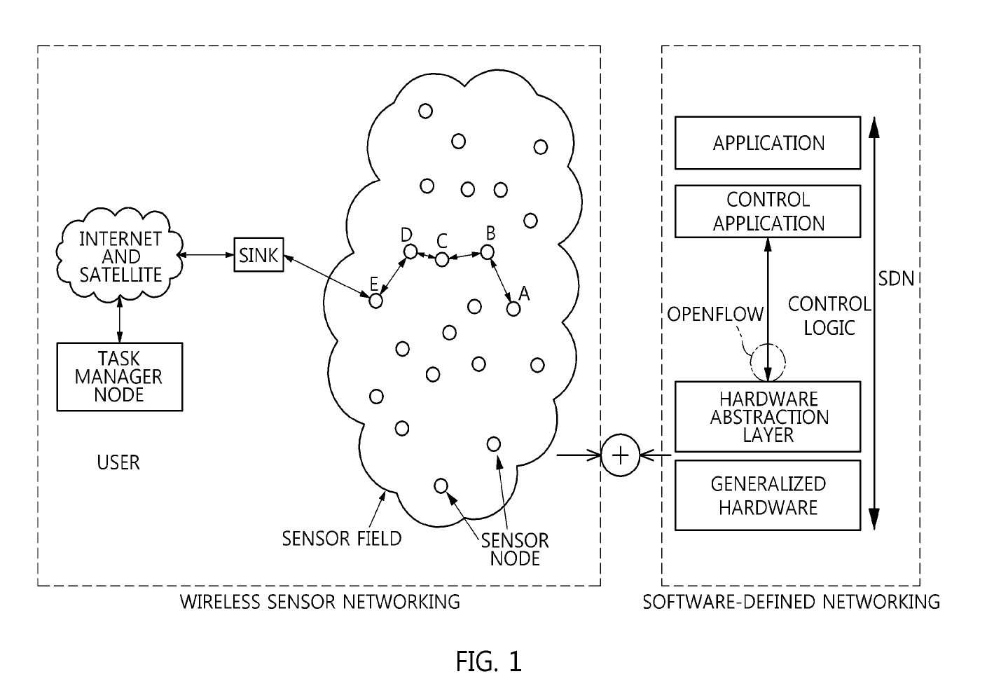

FIG. 1 is a conceptual diagram showing a sensor networking apparatus according to an embodiment.

Referring to FIG. 1, the sensor networking apparatus according to the embodiment of the present invention is configured to combine typical wireless sensor networking with the concept of software defined networking (hereinafter referred to as “SDN”).

That is, the sensor networking apparatus according to the embodiment introduces the concept of software defined networking (SDN) and is then configured to separate sensor nodes from a gateway such that the sensor nodes take charge of a data plane in the same way that the switches of the SDN do and the gateway takes charge of a control plane in the same way that an SDN controller does.

In this way, the sensor networking apparatus according to the embodiment separates the sensor nodes and the gateway, thus minimizing energy consumption of the sensor nodes, and allowing the gateway to support various application services.

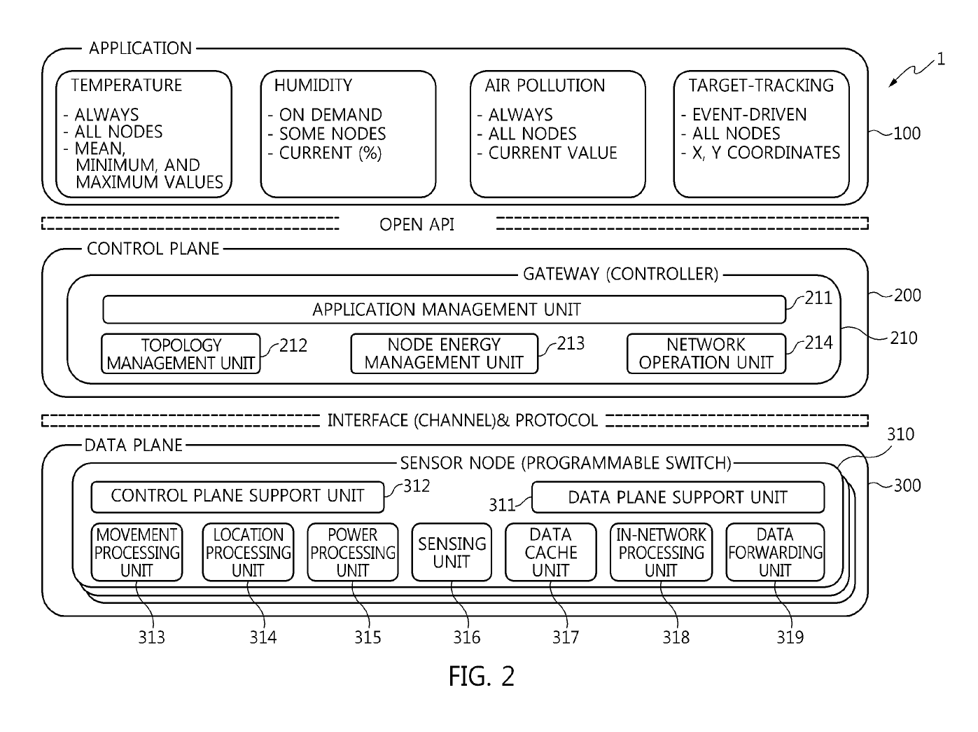

FIG. 2 is a diagram showing the configuration of a sensor networking apparatus according to an embodiment.

Referring to FIG. 2, a sensor networking apparatus 1 according to the embodiment is implemented as a structure including an application 100, a control plane 200, and a data plane 300, and includes a gateway 210 and one or more sensor nodes 310.

The application 100 requests information required for an application service from the gateway 210 of the control plane 200 by transmitting the required information to the gateway 210 from the standpoint of a manager or a user, and provides a policy required for the application service.

As shown in the drawing, the gateway 210 takes charge of the control plane 200 as in the case of a controller which takes charge of the control plane of the SDN, and is configured to receive various types of application services from the application 100, determine information to be requested from each sensor node 310, and transmit the determined information to the corresponding sensor node 310. Further, when response information to the information to be requested is received from each sensor node 310, the gateway 210 may integrate the received response information, determine information to be processed by each sensor node 310, and transmit the determined information to the corresponding sensor node 310 to process the information.

Each sensor node 310 take charges of the data plane 300 as in the case of each SDN switch, and is configured to process the request information of the gateway 210, transmit response information to the gateway 210, and process received information if information to be processed by each sensor node 310 is received from the gateway 210.

In greater detail, as shown in FIG. 2, the gateway 210 includes an application management unit 211, a topology management unit 212, a node energy management unit 213, and a network operation unit 214.

The application management unit 211 receives pieces of application service information of respective application services from the application 100, and manages pieces of information about requirements for respective application services. Further, the application management unit 211 provides various types of information required for network operation, among the pieces of requirement information of respective application services, to the network operation unit 214.

The topology management unit 212 may manage the topology information of the sensor nodes 310 in the network and transfer the information required for network operation, such as topology information, to the network operation unit 214.

That is, the topology management unit 212 may determine information to be collected from each sensor node 310 and transmit request information requesting the determined information to each sensor node 310. In this case, the information to be collected from each sensor node 310 may include node location information, link information, etc. The request information may further include the identification (ID) of each application service and the information of the gateway 210 in addition to the information to be collected from each sensor node 310.

If the node location information, link information, etc. are received from each sensor node 310, the topology management unit 212 may collect the received information and manage the collected information as topology information. Further, if a change occurs in the collected node location information, link information, etc., the topology management unit 212 may define an event corresponding to the change, and transmit the defined event to each sensor node 310.

The node energy management unit 213 may manage information about the energy state of each sensor node 310 in the network and provide the energy state information of each sensor node 310 to the network operation unit 214 so as to operate the network.

That is, the node energy management unit 213 may transmit request information for requesting information to be collected from each sensor node 310, for example, energy state information including the residual energy information of each sensor node 310, to each sensor node 310. If energy state information including the residual energy information is transmitted from each sensor node 310, the node energy management unit 213 may collect the information, manage the energy state information of each sensor node 310, and provide information required to operate the network to the network operation unit 214.

The network operation unit 214 receives various types of information required to operate the network from individual units 211, 212, and 213 of the gateway 210 and determines networking methods for respective application services. Depending on the determined networking methods, the network operation unit 214 may generate forwarding flow tables for data forwarding for respective sensor nodes 310 and in-network flow tables for in-network processing, and transmit the generated tables to the respective sensor nodes 310.

As shown in FIG. 2, each sensor node 310 may include, in greater detail, a data plane support unit 311, a control plane support unit 312, a movement processing unit 313, a location processing unit 314, a power processing unit 315, a sensing unit 316, a data cache unit 317, an in-network processing unit 318, and a data forwarding unit 319.

The data plane support unit 311 functions as an interface between the network operation unit 214 of the gateway 210 and the individual units 316, 317, 318, and 319 for performing internal functions related to a data plane operation. That is, the data plane support unit 311 receives various types of processing information to be processed from the network operation unit 214 of the gateway 210, and transfers the received processing information to the individual units 316, 317, 318, and 319.

The sensing unit 316 senses request information for each application service received from the network operation unit 214 of the gateway 210 through the data plane support unit 311, and then obtains data. In this case, the sensing unit 316 may include sensors capable of sensing various types of information so as to satisfy a variety of application services. Therefore, the sensing unit 316 may include two or more sensors as an occasion demands.

The data cache unit 317 may temporarily store the results of processing by the sensing unit 316, the in-network processing unit 318, and the data forwarding unit 319 in a data cache if necessary. For example, when data included in a packet header is recalculated by the in-network processing unit 318, the data cache unit 37 may temporarily store the recalculated data.

The in-network processing unit 318 may reprocess data included in a packet input through the data plane support unit 311, and then generate new information. In this case, as the new information is generated, previous data may be deleted. Further, the in-network processing unit 318 may perform data merging of processing a plurality of pieces of data and regenerating the processed data as a piece of new data.

The in-network processing unit 318 may receive an in-network flow table required for in-network processing from the gateway 210 through the data plane support unit 311 and manage the in-network flow table. The in-network processing unit 318 may perform in-network processing on the packet input through the data plane support unit 311 by using the in-network flow table.

The data forwarding unit 319 may receive a forwarding flow table for data forwarding, input from the gateway 210, through the data plane support unit 311, and manage the forwarding flow table. Further, if a packet is input through the data plane support unit 311, the data forwarding unit 319 may process the input packet with reference to the forwarding flow table.

The control plane support unit 312 functions as an interface between the topology management unit 212 and the node energy management unit 213 of the gateway 210 and the components of each sensor node 310 for performing a control-related internal function, that is, the movement processing unit 313, the location processing unit 314, and the power processing unit 315.

That is, the control plane support unit 312 receives various types of request information from the gateway 210 and transfers the received requests to each unit 313, 314 or 315 so that the received requests are processed. Further, the control plane support unit 312 receives the results of processing from each unit 313, 314, or 315, and transmits the processing results to the gateway 210.

The movement processing unit 313 is configured to, when each sensor node 310 is moved, process a control packet in relation to the support of mobility.

The location processing unit 314 transfers the location information of the sensor node 310 to the topology management unit 212 of the gateway 210 in response to the request of the gateway 210. Further, the location processing unit 314 may receive location-related event information from the topology management unit 212 of the gateway 210, and if an event occurs, may process an action associated with the event based on received event information.

The power processing unit 315 transfers the residual energy or power-related information of each sensor node 310 to the node energy management unit 213 of the gateway 210. Further, the power processing unit 315 receives energy-related event information from the node energy management unit 213, and if a related event occurs, may process an action associated with the event based on received event information.

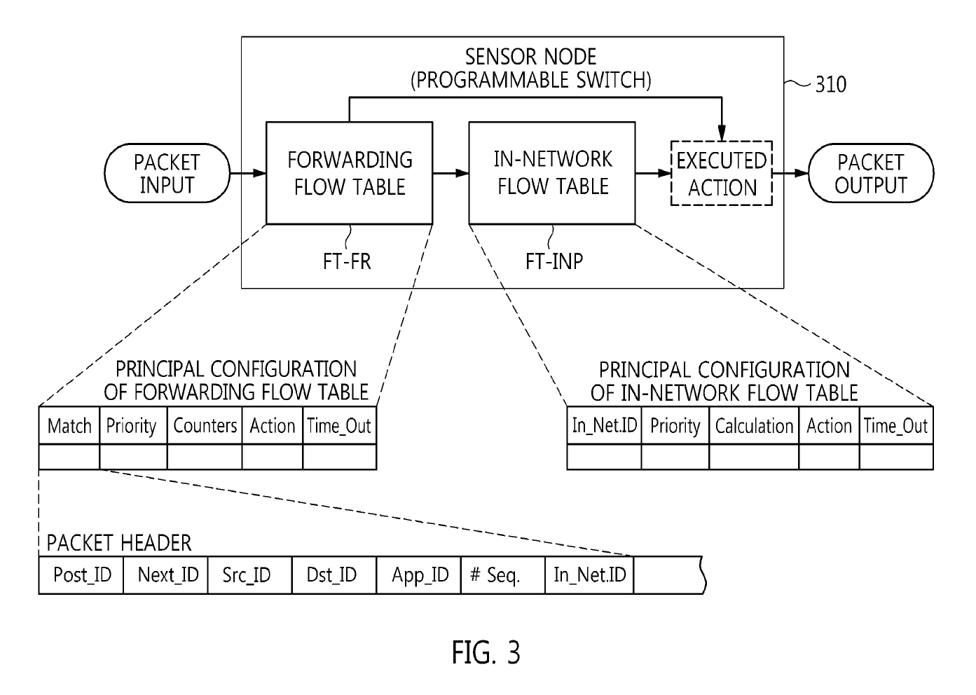

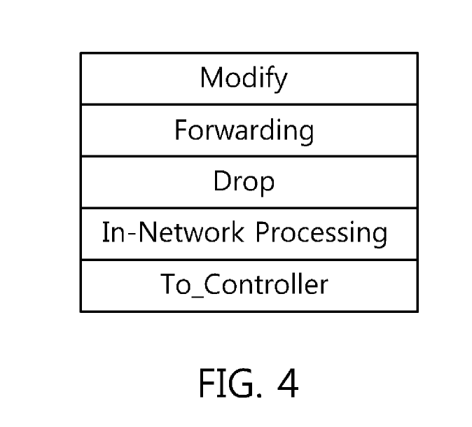

FIG. 3 illustrates the structure of the flow table of a sensor node according to an embodiment. FIG. 4 illustrates the values of the action field of the flow table.

As shown in the drawing, a sensor node 310 manages a forwarding flow table (FT-FR) required to determine a routing path through which an input packet is to be forwarded.

Individual entries of the forwarding flow table (FT-FR) may include Match, Priority, Counters, Action, and Time-out fields. The Match field includes information matching a header field via masking among pieces of packet header information, and generally stores header information. Here, the packet header information may include information such as “Post_ID”, “Next_ID”, “Src_ID”, “Dst_ID”, “App_ID”, and “In_Net_ID.” Further, the Priority field stores information required to determine the sequence of priority processing of individual entries of the forwarding flow table (FT-FR). Further, the Counters field stores information used by the gateway 210 to manage the network based on the statistical information of input packets. The Action field stores information about a method of finally processing a packet having a header matching the Match field. Finally, the Time-out field stores time for which each entry has a valid value, wherein if the value of the time-out field value becomes “0”, the corresponding entry is deleted from the forwarding flow table (FT-FR).

Meanwhile, the Action field may include five types of information, that is, “Modify”, “Forwarding”, “Drop”, “In-Network Processing”, and “To-Controller,” as shown in FIG. 4. “Modify” is used when a packet is processed in different manners as input packet header information is modified. “Forwarding” denotes information indicating a routing path through which the input packet is to be forwarded. “Drop” is used to discard an input packet. “In-Network Processing” is used when there is a need to reprocess data in the input packet, wherein the packet is transferred together with included information “In-Net-ID” to the in-network processing unit 318 for in-network processing. “To-Controller” is used to transfer packet header information to the gateway 210, which is the controller, in order to perform exception handling on the corresponding packet. In this case, the packet header transferred via the action “To-Controller” is temporarily stored in the sensor node 310 until a processing method is transferred from the gateway 210.

Further, the sensor node 310 manages an in-network flow table (FT-INP) so as to process a packet requiring in-network processing as a result of data forwarding using the forwarding flow table (FT-FR).

As shown in the drawing, the in-network flow table (FT-INP) may include In-Net-ID, Priority, Calculation, Action, and Time-Out fields. The In-Net_ID field stores an ID issued for data processing for each application service, and may have a plurality of in-network processing entries for one application service. The Priority field stores information about the sequence of priority processing between the in-network processing entries in this way. The Calculation field stores information about which calculation formula or conditional expression is to be used to process data included in the packet. The Action field stores a method of finally processing a packet processed by the calculation formula or the conditional expression. Information stored in the Action field is identical to that described above with reference to FIG. 4. Further, the Time-Out field has information about time for which each entry has a valid value, wherein, when this value becomes “0”, the corresponding entry is deleted from the in-network flow table.

The sensor node 310 searches the in-network flow table (FT-INP) for an entry matching In-Net-ID information, received together with a packet requiring in-network processing, recalculates data using the Calculation field of the entry, finally processes the packet depending on the value of the Action field, and outputs the processed packet.

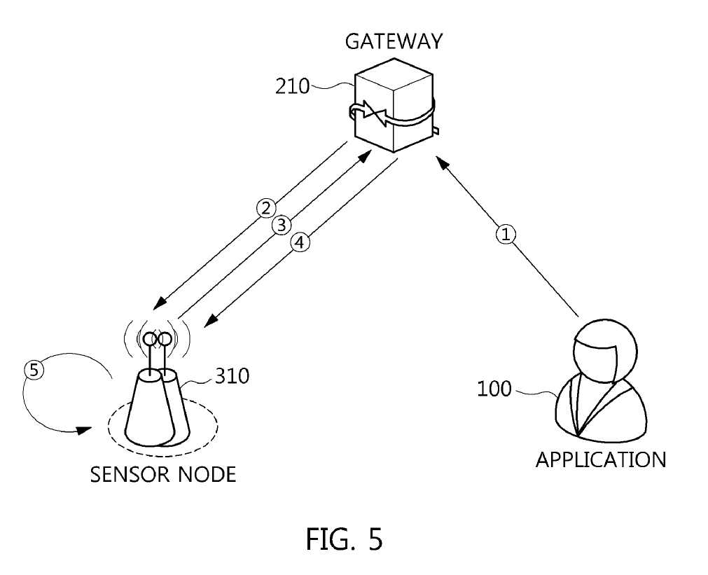

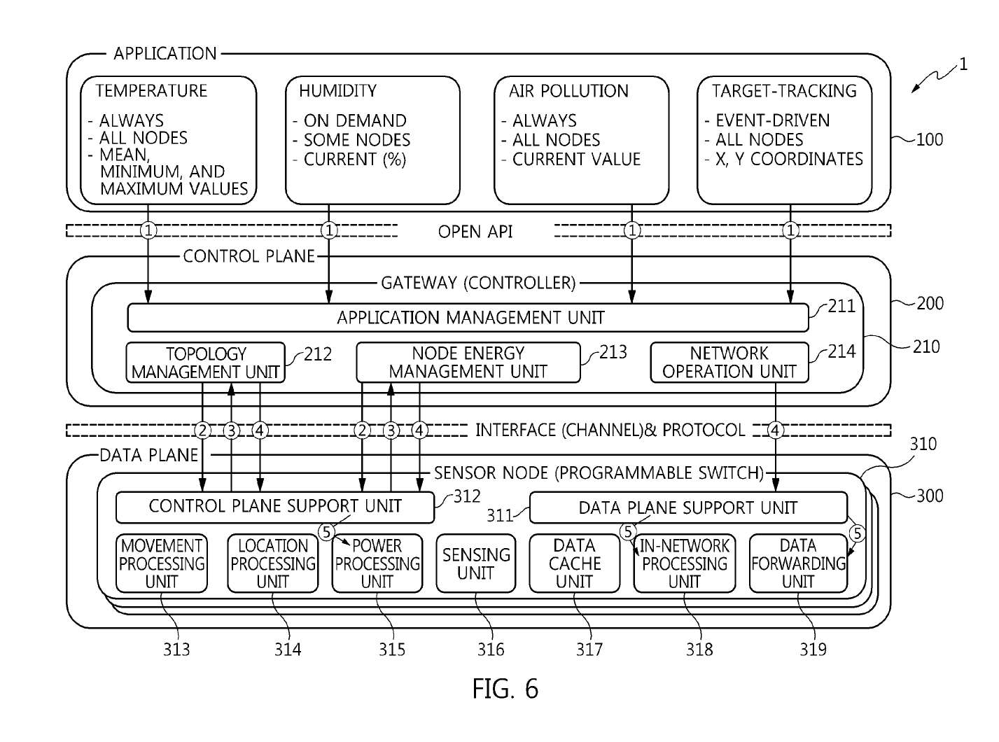

FIGS. 5 and 6 are diagrams showing an example of a networking service performed by the sensor networking apparatus according to an embodiment.

A procedure in which the gateway 210 of the sensor networking apparatus 1 performs a network initialization operation, among the operations of the control plane 200, will be described in detail with reference to FIGS. 5 and 6.

As shown in the drawing, the application management unit 211 of the gateway 210 receives various types of application service information from the application 100 (\textcircled{1}). The application management unit 211 transfers the various types of application service information to the topology management unit 212, the node energy management unit 213, and the network operation unit 214.

The topology management unit 212, the node energy management unit 213, and the network operation unit 214 of the gateway 210 determine information to be requested from each sensor node 310, and transmits information to be requested, together with the ID of an application service, the gateway information, etc., to the control plane support unit 312 of the sensor node 310(\textcircled{2}).

Each sensor node 310 checks the information requested by the gateway 210, for example, the location information of the sensor node, residual energy information, etc., and returns the checked information to the gateway 210 (\textcircled{3}).

The gateway 210 integrates pieces of information received from the respective sensor nodes 310, determines information for networking, such as a routing path, and information for in-network processing, and retransmits the determined information to the sensor node 310 (\textcircled{4}).

Each sensor node 310 performs the corresponding operation of the data plane 300 using the received information. For example, by means of information received through the control plane support unit 312, the power processing unit 315 may perform the operation of processing a related event when the event occurs. Further, by means of information received through the data plane support unit 311, the data forwarding unit 319 performs the operation of adding the entry of the forwarding flow table or, alternatively, the in-network processing unit 318 performs the operation of adding the entry of the in-network flow table (\textcircled{5}). In this case, the data cache unit 317 may temporarily store the data in a data cache.

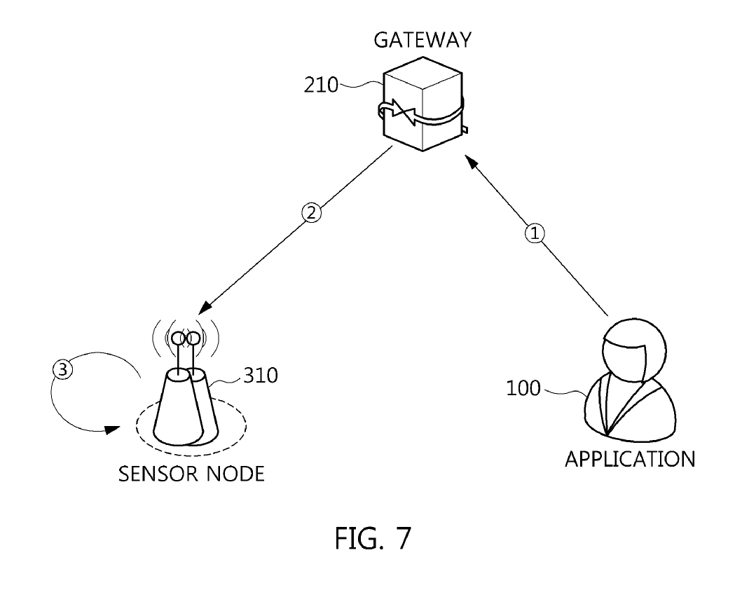

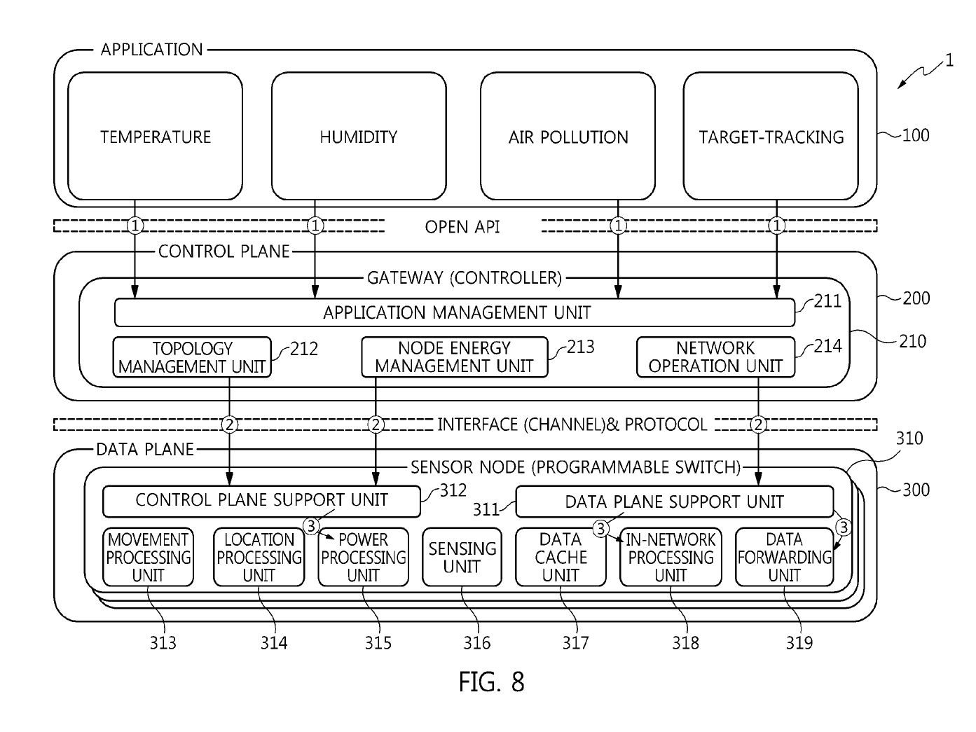

FIGS. 7 and 8 are diagrams showing another example of a networking service performed by the sensor networking apparatus according to an embodiment.

A procedure in which the gateway 210 of the sensor networking apparatus 1 performs the operation of modifying a networking policy, among the operations of the control plane 200, will be described in detail with reference to FIGS. 7 and 8.

The application management unit 211 of the gateway 210 may receive information about the revision of an application service or the addition of a new application service from the application 100 (\textcircled{1}). The application management unit 211 transfers the received information about the revision of the application service or the addition of the new application service to the topology management unit 212, the node energy management unit 213, and the network operation unit 214.

The topology management unit 212, the node energy management unit 213, and the network operation unit 214 of the gateway 210 may modify an existing networking policy to be processed by each sensor node 310, or may delete an existing policy and determine a new policy. That is, IDs and new information related to the revised or new application service may be integrated, so that information for networking, such as a routing path, and information for in-network processing may be revised or newly determined and may be transmitted to the each sensor node 310 (\textcircled{2}).

The control plane support unit 312 or the data plane support unit 311 of each sensor node 310 may receive various types of information from the gateway 210 and support the performance of the operation of the data plane 300. For example, the power processing unit 315 may receive revised or new power-related event information, and the data forwarding unit 319 or the in-network processing unit 318 may revise or add the entries of the forwarding flow table or the in-network flow table (\textcircled{3}).

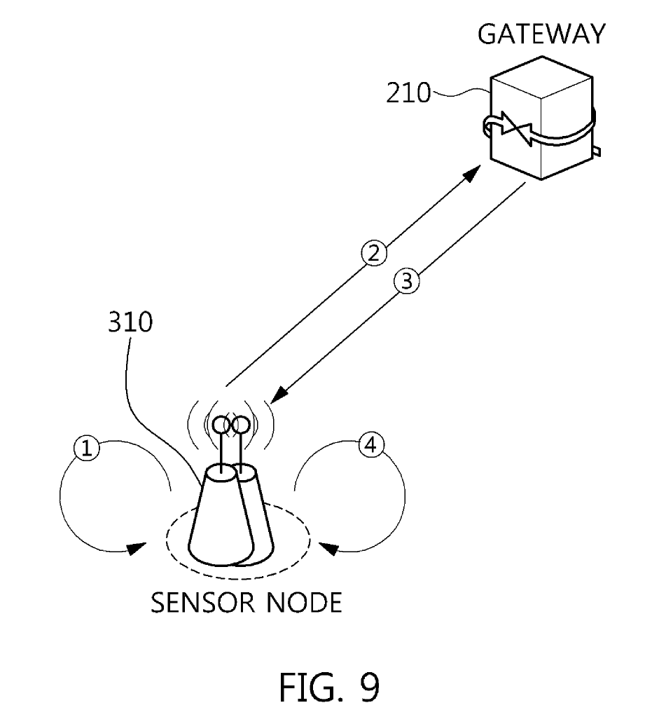

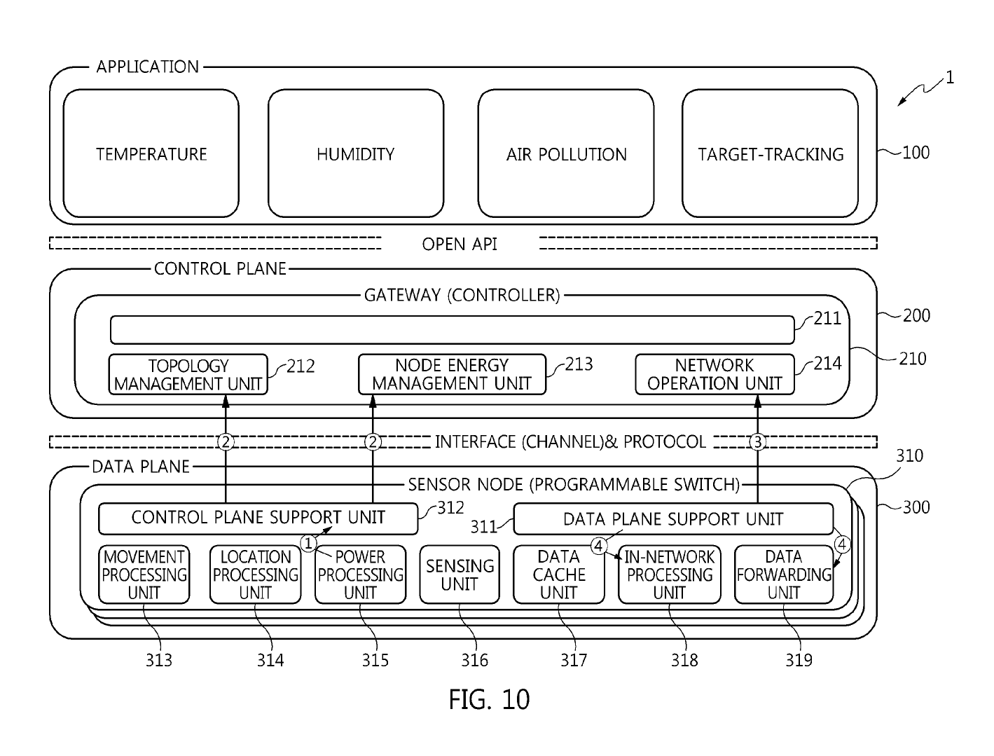

FIGS. 9 and 10 are diagrams showing a further example of a networking service performed by the sensor networking apparatus according to an embodiment.

A procedure in which the gateway 210 of the sensor networking apparatus 1 performs the operation of modifying a networking policy due to the generation of an event, among the operations of the control plane 200, will be described in detail with reference to FIGS. 9 and 10.

A networking policy determined by the gateway 210 is designated such that, when an event occurs, each sensor node 310 transfers the state information thereof to the gateway 210. For example, when the residual energy of each sensor node 310 of the data plane 300 falls short of a standard or when the location of the sensor node 310 changes, if an event occurs in the sensor node 310 (\textcircled{1}), the power processing unit 315 or the location processing unit 314 of the sensor node 310 transmits residual energy information or location information of the sensor node to the energy management unit 213 or the topology management unit 212 of the gateway 210 through the control plane support unit 312 (\textcircled{2}).

The gateway 210 receives the residual energy information or location information from the sensor node 310, and modifies a networking policy for an existing application service via the topology management unit 212, the node energy management unit 213, and the network operation unit 214. Then, the gateway 210 transmits the modified networking policy (for example, a routing route or the like) to the sensor node 310 (\textcircled{3}).

The entry of the forwarding flow table or the in-network flow table in the sensor node 310 may be revised or a new entry may be added to the flow table (\textcircled{4}).

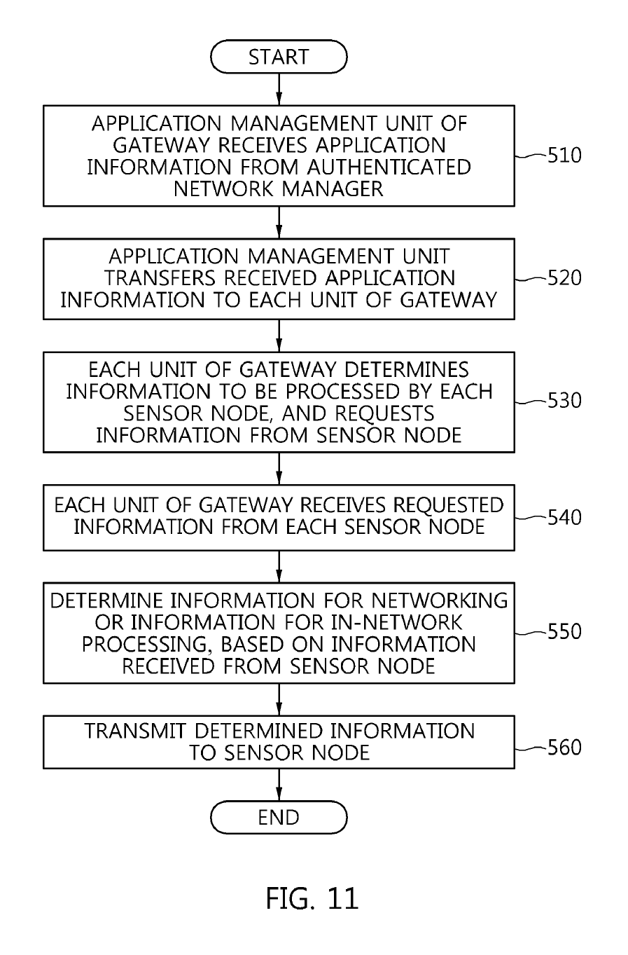

FIG. 11 is a flowchart showing a sensor networking service method performed by the gateway according to an embodiment.

As an embodiment of various control plane operations performed by the gateway, that is, the sensor networking service method, a network initialization procedure will be described in detail with reference to FIG. 11.

First, the application management unit of the gateway receives application service information of various types of applications from an authenticated network manager at step 510.

Next, the application management unit transfers the received application service information to each unit of the gateway which performs a control plane function at step 520.

Then, each unit of the gateway determines request information to be processed by each sensor node, for example, the location information or residual energy information of each sensor node, and requests the determined information by transmitting the determined information to the sensor node at step 530. In this case, the ID of each application service and the information of the gateway may be transmitted together with the determined information.

Thereafter, each unit of the gateway receives requested information from each sensor node at step 540, and determines information for networking (for example, a routing path or the like) or information for in-network processing, based on the received information at step 550.

Then, the determined information is transmitted to each sensor node at step 560. Each sensor node may perform the operation of revising or adding the entry of the forwarding flow table for data forwarding or the in-network flow table for in-network processing, based on the received information.

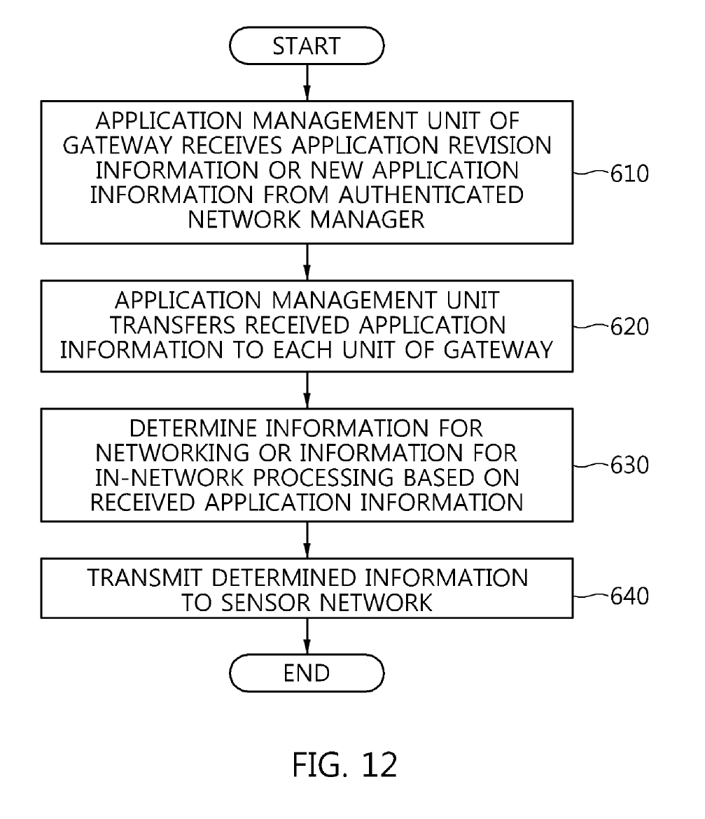

FIG. 12 is a flowchart showing a sensor networking service method performed by the gateway according to another embodiment.

Another embodiment of the sensor networking service method performed by the gateway will be described in detail with reference to FIG. 12.

The application management unit of the gateway receives information about the revision of an application service or the addition of a new application service from an authenticated network manager at step 610, and transfers the received information about the revision of the application service or the addition of the new application service to each unit which performs a control plane function at step 620.

Next, each unit of the gateway modifies an existing networking policy to be processed by each sensor node, or deletes the existing policy and determines a new policy at step 630. That is, IDs and new information related to the revised or new application service may be integrated, so that information for networking, such as a routing path, and information for in-network processing may be revised or newly determined.

Then, the determined information may be transmitted to the sensor network, so that each sensor node may perform a data plane operation using the received information at step 640. For example, the sensor node may revise or add the entry of the forwarding flow table or the in-network flow table using the received information.

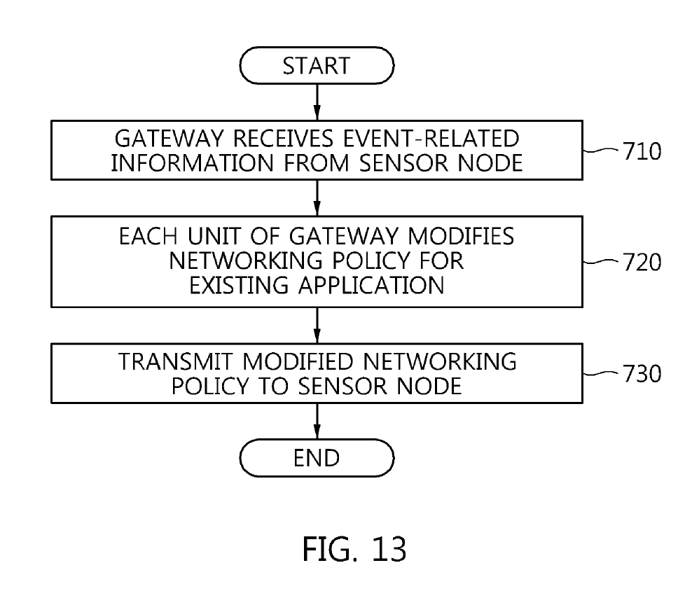

FIG. 13 is a flowchart showing a sensor networking service method performed by the gateway according to a further embodiment.

A further embodiment of the sensor networking service method performed by the gateway will be described in detail with reference to FIG. 13.

The gateway receives event-related information from each sensor node at step 710. The networking policy determined by the gateway is designated such that, when an event occurs, each sensor node transfers the state information thereof to the gateway. In this way, when the residual energy of each sensor node in the data plane falls short of a standard or when the location of the sensor node changes, an event occurs on the sensor node 310. When the event occurs, the sensor node 310 measures residual energy information or location information, and transmits the measured information to the gateway.

Thereafter, each unit of the gateway modifies a networking policy related to an existing application service based on the received event-related information, for example, the residual energy information or location information of the corresponding sensor node, at step 720.

Then, the gateway transmits the modified policy to the sensor node at step 730. The sensor node may revise or add the entry of the forwarding flow table or the in-network flow table in conformity with the modified policy.

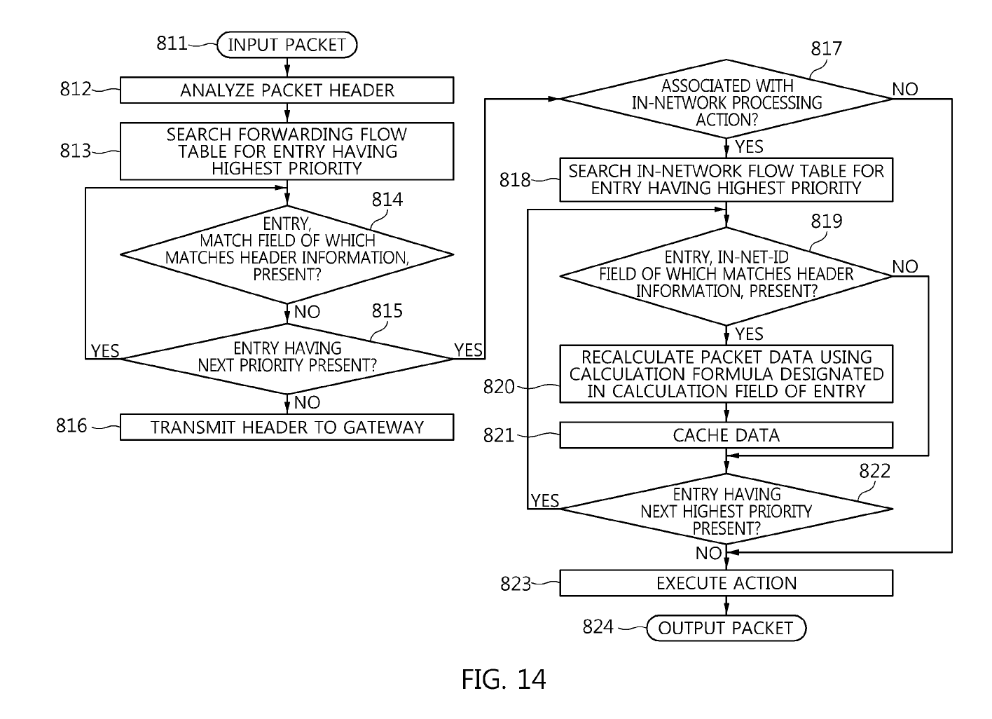

FIG. 14 is a flowchart showing a sensor networking service method performed by a sensor node according to an embodiment.

Below, the sensor networking service method performed by the sensor node will be described in detail with reference to FIG. 14. First, if a packet is input to the sensor node at step 811, the sensor node analyzes the header of the packet at step 812.

Next, the sensor node searches a forwarding flow table for the entries of in the sequence of higher priorities at step 813, and determines whether an entry, the Match field of which matches the header information of the packet, is present at step 814. If a plurality of entries, the Match field of which matches the header information, are present, an entry having highest priority is first processed depending on the priority, and an entry having second highest priority is then processed.

If the header information of the packet matches neither the entry having the highest priority nor entries having the next highest priority at step 815, the sensor node transmits the header information to the gateway that is a controller, receives a modified policy related to the processing of the corresponding packet, and processes the packet in conformity with the modified policy.

If the Action field of the matching entry has ‘In-Network Processing’ information at step 817, the sensor node searches the in-network flow table for an entry having highest priority at step 818. In this case, if the Action field of the matching entry does not have the ‘In-Network Processing’ information, the sensor node executes and processes a current action in the Action field at step 823.

It is determined whether the In-Net-ID field of the found entry having the highest priority matches the header information at step 819. If it is determined that the In-Net-ID field matches the header information, the sensor node recalculates the data of the packet using a calculation formula designated in the Calculation field of the entry at step 820. In this case, if the In-Net-ID field does not match the header information, the sensor node determines whether an entry having next highest priority is present at step 822.

Meanwhile, the sensor node temporarily stores the recalculated data in a data cache at step 821, and determines whether an entry having next highest priority is present at step 822. If it is determined that the entry having next highest priority to be processed is present, the sensor node repeatedly performs a procedure starting from step 819.

Thereafter, if an entry to be processed is not present any more, the sensor node processes the packet depending on the Action field of the last entry at step 823, and outputs the packet at step 824.

The present invention is advantageous in that the concept of Software Defined Networking (SDN) is combined with a sensor network, so that sensor nodes take charge of a data plane in the same way that the switches of the SDN do, thus minimizing energy consumption.

Further, the present invention is advantageous in that a gateway takes charge of a control plane in the same way that the controller of the SDN does, so that the gateway performs collective network control, thus supporting various application services.

Those skilled in the art to which the present embodiments pertain will appreciate that the present invention may be implemented in other detailed forms without changing the technical spirit or essential features of the present invention. Therefore, the above-described embodiments should be understood to be exemplary rather than restrictive in all aspects.

What is claimed is:

1. A programmable sensor networking apparatus, comprising:
a gateway for receiving application service information from an application, generating information to be processed by each sensor node based on the received application service information, and transmitting the generated information to each sensor node; and
one or more sensor nodes for receiving the information to be processed from the gateway, and processing the received information.

2. The programmable sensor networking apparatus of claim 1, wherein the gateway comprises:
an application management unit for receiving the application service information from the application, and transmitting networking information to a network operation unit based on the received application service information; and
the network operation unit for determining networking methods for respective application services based on the networking information received from the application management unit.

3. The programmable sensor networking apparatus of claim 2, wherein the network operation unit generates pieces of information about flow tables for respective sensor nodes based on the determined networking methods, and transmits the pieces of flow table information to the respective sensor nodes.

4. The programmable sensor networking apparatus of claim 3, wherein each of the flow tables includes one or more of a forwarding flow table and an in-network flow table for each sensor node.

5. The programmable sensor networking apparatus of claim 2, wherein the gateway further comprises a topology management unit for receiving one or more of node location information in a network and link information from each sensor node, and managing topology information of the sensor node in the network.

6. The programmable sensor networking apparatus of claim 2, wherein the gateway further comprises a node energy management unit for receiving energy state information including residual energy information from each sensor node and managing energy information of the sensor node in the network.

7. The programmable sensor networking apparatus of claim 1, wherein each sensor node comprises a data forwarding unit for managing a forwarding flow table received from the gateway, and processing an input packet based on the forwarding flow table.

8. The programmable sensor networking apparatus of claim 7, wherein each sensor node further comprises:
an in-network processing unit for managing an in-network flow table received from the gateway, and if the input packet is a packet for in-network processing, reprocessing data included in the input packet based on the in-network flow table; and
a data cache unit for storing the data reprocessed by the in-network processing unit.

9. The programmable sensor networking apparatus of claim 8, wherein each sensor node further comprises a data plane support unit for receiving information to be processed from the gateway, and transferring the received information to a corresponding unit so as to process the received information.

10. The programmable sensor networking apparatus of claim 1, wherein each sensor node comprises:
a location processing unit for transferring location information of the sensor node to the gateway in response to a request of the gateway; and
a power processing unit for transferring power information of the sensor node to the gateway in response to a request of the gateway.

11. The programmable sensor networking apparatus of claim 10, wherein each sensor node further comprises a movement processing unit for processing a control packet related to support of mobility if the sensor node is moved.

12. The programmable sensor networking apparatus of claim 11, wherein each sensor node further comprises a control plane support unit for receiving information to be processed from the gateway, transferring the received information to a corresponding unit so as to process the received information, receiving results of processing from the unit, and transmitting the processing results to the gateway.

13. A sensor networking service method, the method being performed by a gateway of a programmable sensor networking apparatus, comprising:
receiving one or more application services from an application;
determining information to be collected from one or more sensor nodes, based on the received application services;
transmitting request information for the information to be collected to each sensor node;
receiving response information to the request information from each sensor node;
determining information to be processed by each sensor node based on the received response information; and
transmitting the information to be processed to each sensor node.

14. The sensor networking service method of claim 13, wherein:
the request information includes the information to be collected having one or more of location information and residual energy information of each sensor node, identifications (IDs) of the respective application services, and gateway information, and
the information to be processed by each sensor node includes one or more of networking information including a routing path and in-network processing information.

15. The sensor networking service method of claim 13, further comprising:
receiving information about revision or addition information of an application service from the application;
re-determining information to be processed by each sensor node based on the received revision or addition information of the application service; and
transmitting the re-determined information to be processed to each sensor node.

16. The sensor networking service method of claim 13, further comprising:
receiving event-related information from each sensor node;
revising information to be processed by each sensor node for an existing application service based on the received event-related information; and
transmitting the revised information to be processed by each sensor node to the corresponding sensor node.

17. A sensor networking service method, the method being performed by each sensor node of a programmable sensor networking apparatus, comprising:
receiving a packet to be processed from a gateway;
performing a data forwarding procedure on the received packet, based on a forwarding flow table; and
if in-network processing of the packet is required, performing an in-network processing procedure on the packet, based on an in-network flow table.

18. The sensor networking service method of claim 17, wherein performing the data forwarding procedure comprises:
analyzing header information of the received packet;
searching the forwarding flow table for an entry, a Match field of which matches the analyzed header information; and
processing the packet depending on an Action field of the entry found in the forwarding flow table.

19. The sensor networking service method of claim 18, further comprising:
searching the in-network flow table for an entry, an In-Net-ID field of which matches the analyzed header information;
recalculating data included in the packet depending on a Calculation field of the entry found in the in-network flow table; and
processing the packet depending on an Action field of the found entry.

20. The sensor networking service method of claim 19, wherein recalculating the data included the packet is configured to, if two or more entries are found as a result of search, recalculate data included in the packet in a sequence of entries having higher priority based on a Priority field of the found entries.
